(19) United States
(12) Patent Application Publication
(10) Pub. No.: US 2014/0089002 A1
(43) Pub. Date: Mar. 27, 2014

(54) HIPAA COMPLIANT HEALTH INFORMATION SHARING DISPLAY AND METHOD

(71) Applicant: Amar P. Kamath, Sparta, NJ (US)

(72) Inventor: Amar P. Kamath, Sparta, NJ (US)

(21) Appl. No.: 13/623,883

(22) Filed: Sep. 21, 2012

(51) Int. Cl. G06Q 50/24

(52) U.S. Cl. 705/3

(57) ABSTRACT

A privacy genetic testing and display method in which a group of two or more individuals is tested for genetic markers of types specified by at least one of the individuals, and the markers found are displayed to a requesting individual of the group without initially identifying any other individual who has not consented to being identified; and upon consent of each individual of the group, the display presented to the requesting individual is modified to identify the consenting individual.

### BACKGROUND OF THE INVENTION

The present invention relates to medical testing of people who are or may be or become related, to determine the risk of a particular person developing a disease or a particular couple having children who might have or develop the disease, and to present the test results in a way that respects the privacy of all participants in compliance with the Health Insurance Portability and Accountability Act of 1996 (“HIPAA”).

Genetic material of individuals, usually obtained from blood or tissue samples, is frequently tested for genetic markers known to constitute risk factors for various diseases. Where two persons of opposite sex contemplate having children, it is often important to determine the risk that their child might have or develop a serious genetically related disease.

In some situations it is desirable to perform such genetic tests in a manner that preserves the privacy of tested individuals. For example, a person concerned about developing a genetically related disease may wish to determine the extent of the presence of corresponding genetic markers among that person's relatives, and the relatives may be willing to give genetic material specimens anonymously, but not want that person to be able to link the results to them without their subsequent consent, after they know the results.

A similar situation occurs in the orthodox Jewish community where in some cases marriages are arranged by a third party such as a rabbi or matchmaker introducing potential marriage partners. In such cases it is desirable that no such introduction occur until it has been determined that there is no significant risk of children of the potential partners developing a serious or fatal condition such as Tay-Sachs disease, which is prevalent in the Jewish community; and that the potential partners not know each other's identity until the testing has been successful.

For these reasons there is need for a method of testing a group of two or more individuals for genetic markers indicative of disease or another undesirable condition while providing medical information privacy as required by HIPAA.

U.S. Pat. No. 8,019,620 to Miller et al. entitled System and Method For Medical Privacy Management discloses an electronic medical records (“EMR”) system including request manager, release manager, and privacy status manager modules for validating information requests according to privacy criteria associated with a corresponding patient.

U.S. Pat. No. 7,992,002 to Bradbury entitled Data Depository and Associated Methodology Providing Secure Access Pursuant to Compliance Standard Conformity relates to an EMR data depository with an access controller for approving or denying a request for access to data.

U.S. Pat. No. 7,936,913 to Nordell et al. entitled Network Image Review In Clinical Hematology describes a hematology imaging system capable of selectively (i) removing sensitive HIPAA information (that is, patient identifying information) from an image or (ii) including the same in the image.

U.S. Pat. No. 7,890,748 to Wyatt entitled System and Method For HIPAA Compliant Communication shows a system for allowing providers to securely exchange EMR information.

These references show it is known to electronically modify an image relating to protected health information so as to delete patient identifying information, and it is also known to control access to such information based on privacy criteria.

However, these patents do not show or suggest a system wherein protected health information relating to two or more individuals is initially deleted from an image (or a database) which shows whether or not there are genetic markers common to the individuals (and if so shows how many such markers there are); and adds to the image personal identifying information as to the individuals having common markers upon consent of the individuals involved.

### SUMMARY OF THE INVENTION

As herein described, a method is provided for confidentially matching genetic characteristics of a group of individuals, a specimen of genetic material being obtained from each individual. Personal identification information is associated with each specimen which identifies the corresponding individual. The specimens are tested for genetic markers of types specified by at least one of the corresponding individuals, and an individual record of the markers found is generated for each specimen. From the individual records, a result chart is generated for each individual requesting the same. The result contains personal identification information of the requesting individual only. Upon consent of an individual of the group other than the requesting individual, the result chart of the requesting individual is modified to display personal identification information of each consenting individual.

IN THE DRAWING

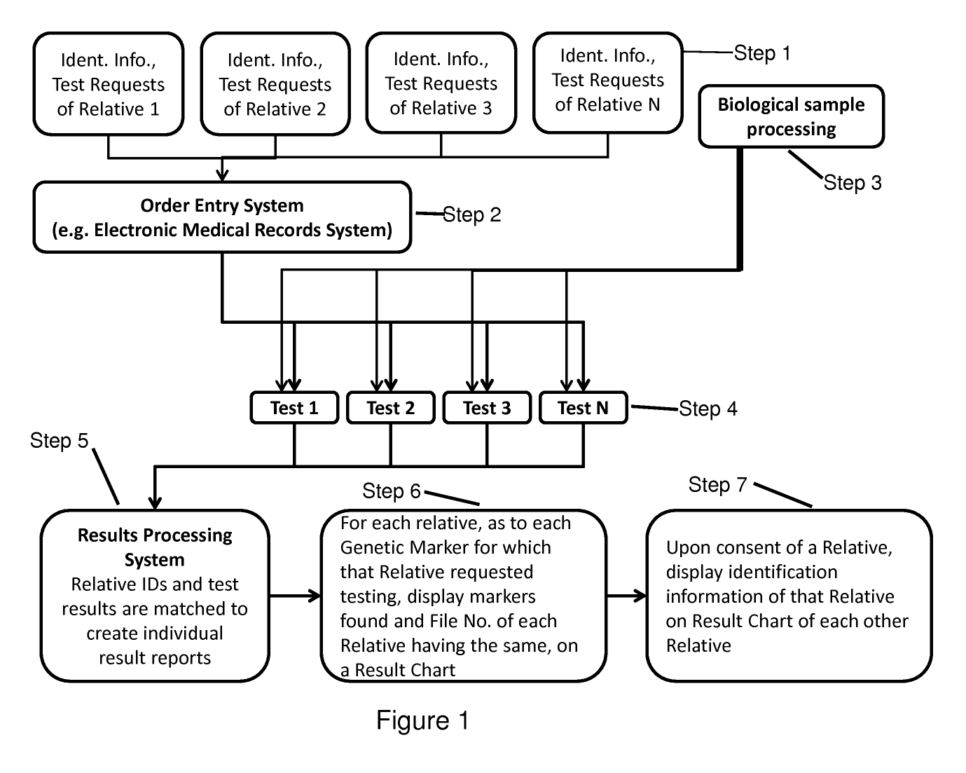

FIG. 1 is a flow chart showing the steps involved in carrying out the method of the present invention.

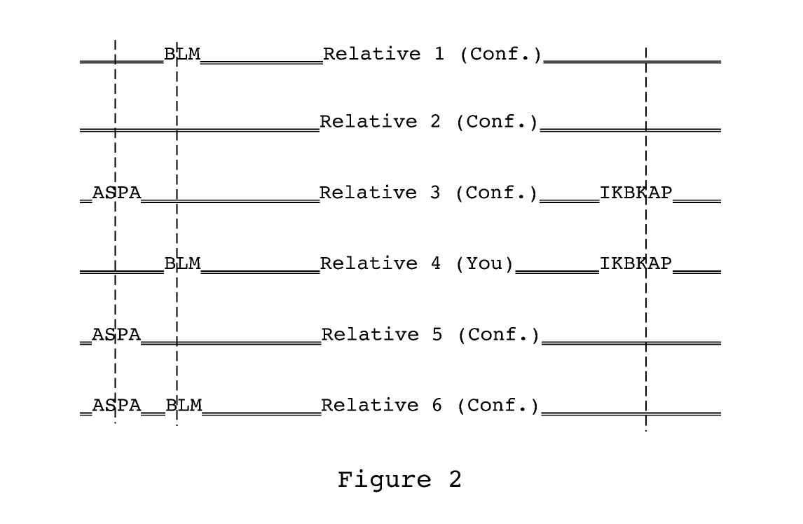

FIG. 2 is a sample result chart regarding a test of a group of six individuals.

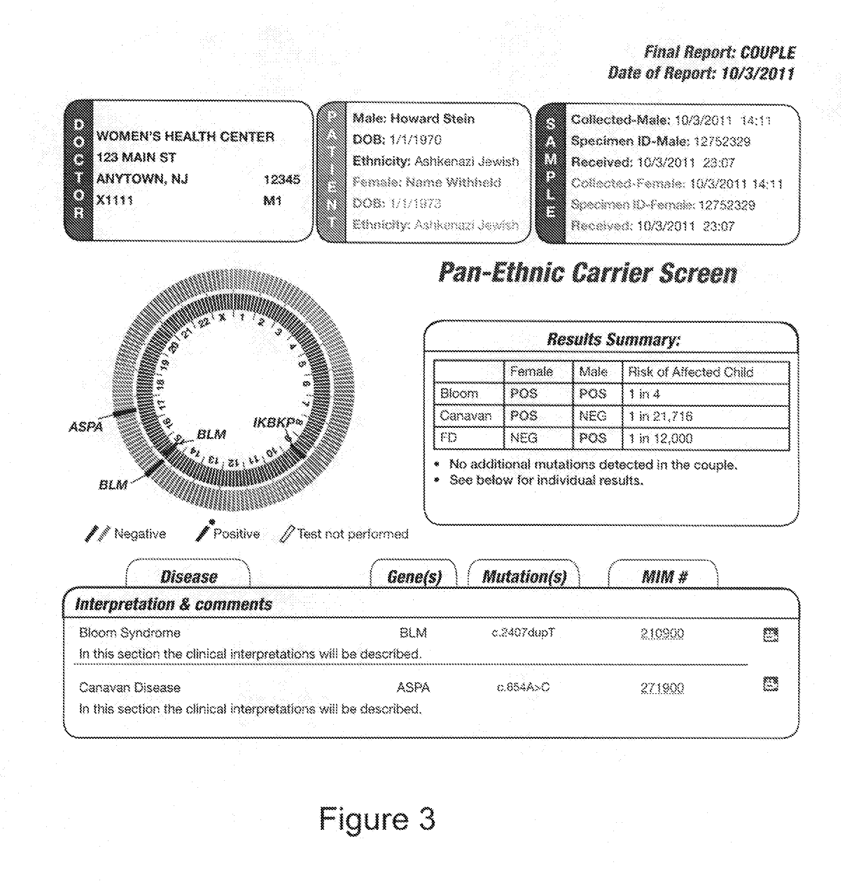

FIG. 3 is a sample result chart in concentric circle form, for a test of a group of two individual.

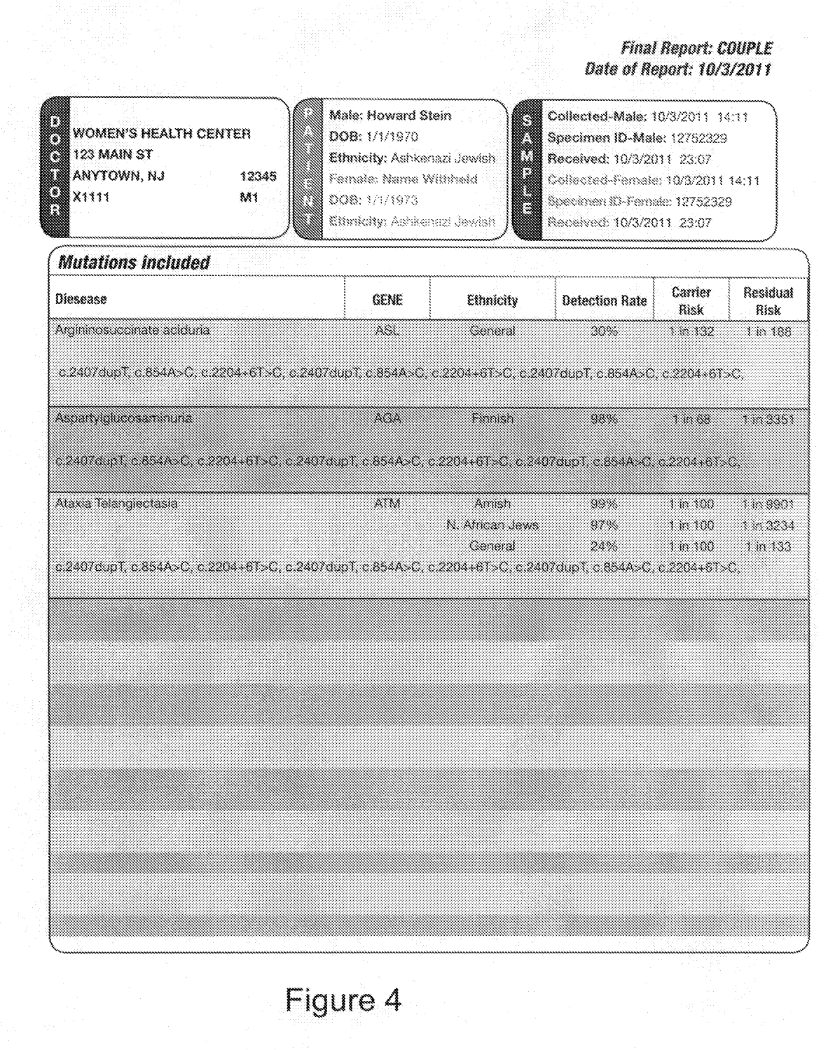

FIG. 4 is a sample ancillary display of additional information regarding the genetic markers that appear in the result chart of FIG. 3.

### DETAILED DESCRIPTION

The term “relatives” as used herein means persons who are or may be or become related, or a couple or potential couple who may have a child.

According to a preferred embodiment of the invention, as shown in FIG. 1, at Step 1 personal identification information is obtained from each relative in the group to be tested. That information typically includes name, sex, date of birth, and ethnic background (if relevant to the tests to be performed). If a relative requests that certain types of genetic markers be tested for, that information is also obtained.

At Step 2 the information gathered in Step 1 is input to an order entry system such as an electronic medical records (“EMR”) system. The EMR system determines which tests are to be performed on which specimens. In most cases, the system will direct that all tests requested by all requesting relatives be performed on all specimens.

At Step 3 genetic material specimens are taken from each individual of the group, and a unique personal identifier such as a specimen ID is assigned to associate the specimen with the corresponding relative.

At Step 4 the specimens are tested as directed by the EMR system, for genetic markers of types specified by the requesting relatives, and an individual record of the markers is created for each specimen.

St Step 5 the specimen IDs are matched to the test results to create individual result reports and/or records. At Step 6 a result chart is generated and displayed (meaning shown on an electronic display and/or printed on paper) which shows the markers found for each relative and a confidential identifier for that relative, such as the specimen ID number or a file number. The display made available to each requesting relative shows the personal identification information for that relative only.

FIG. 2 shows a sample result chart in the form of a linear display, for a tested group of six individuals. In this example Relative 4 is the person requesting the tests, and has markers for BLM (Bloom Syndrome) and IKBKAP (Familial Dysautonmia). Relative 6 has markers for ASPA (Canavan Disease) and BLM. Thus both Relatives 4 and 6 have BLM markers.

In the FIG. 2 example, Relative 4 is male and Relative 6 is female. If a matchmaker was considering introducing these relatives to each other, only their genetic material would be tested. A corresponding result chart could be in linear form, or preferably in concentric circle form as shown in FIG. 3 where identical markers are radially aligned, and in which the concentric rings are preferably color coded to designate sex.

The results chart of FIG. 3 identifies the requesting relative (Howard Stein in the example) but the area where the name of the other relative (Rachel Cohen) would appear is blacked out or having “Name Withheld” displayed and therefore not visible on Howard Stein's result chart, thus protecting Rachel Cohen's privacy. Similarly, the results chart for made available to Rachel Cohen would show her personal identification information and would have Howard Stein's name grayed out.

If Rachel Cohen and Howard Stein, after seeing or being advised of the test results, consent to have their identities disclosed, the grayed out areas on their respective displays would be filled in with the corresponding names.

Similarly, in the example of FIG. 2, the terms “Conf.” referring to each relative would be replaced by the name of the relative upon that relative consenting to waive his or her privacy right. These changes wherein the display made available to a relative is modified to show the name of each consenting relative, is shown as Step 7 in FIG. 1.

Rather than showing the results chart of FIG. 2 in linear form, it may be shown in the form of six concentric circles in a manner similar to FIG. 3.

As shown in FIG. 3, the display may optionally include a results summary giving risk assessments, and information as to the markers shown and/or links to websites providing additional information.

FIG. 4 illustrates the manner in which additional information may be included in each results chart.

I claim:

1. A method for confidentially matching genetic characteristics of a group of individuals, comprising the steps of:
obtaining a specimen of genetic material from each individual;
associating personal identification information with each specimen which identifies the corresponding individual;
testing each specimen for genetic markers of types specified by at least one of the corresponding individuals, and generating an individual record of the markers found for each specimen;
from the individual records, generating a result chart for each individual requesting the same which contains personal identification information of the requesting individual only; and
upon consent of an individual of the group other than the requesting individual, modifying the result chart of the requesting individual to display personal identification information of each consenting individual.

2. The method according to claim 1, wherein the displayed personal identification information includes the sex of each consenting individual.

3. The method according to claim 1, wherein the result chart comprises concentric rings, each ring containing the genetic markers of a corresponding individual of the group and personal identification information of the requesting individual and each consenting individual.
